(19) United States
(12) Patent Application Publication
(10) Pub. No.: US 2024/0291108 A1
(43) Pub. Date: Aug. 29, 2024

(54) MULTILAYER BODY FOR BATTERY, AND METHOD FOR PRODUCING MULTILAYER BODY FOR BATTERY

(71) Applicant: NITTO DENKO CORPORATION, Ibaraki-shi, Osaka (JP)

(72) Inventors: Kyotaro YAMADA, Ibaraki-shi, Osaka (JP); Yuki TAKEDA, Ibaraki-shi, Osaka (JP); Motoki HAISHI, Ibaraki-shi, Osaka (JP); Kenji FURUTA, Ibaraki-shi, Osaka (JP)

(21) Appl. No.: 18/573,979

(22) PCT Filed: Jun. 27, 2022
(86) PCT No.: PCT/JP2022/025599

§ 371 Date: Dec. 22, 2023

(30) Foreign Application Priority Data
Jun. 28, 2021 (JP) 2021-106551

(51) Int. Cl. H01M 50/451; H01M 50/403; H01M 50/489

(52) U.S. Cl. CPC H01M 50/451; H01M 50/403; H01M 50/489

(57) ABSTRACT

A multilayer body for a battery according to the present invention includes: a separator including a porous base material formed in a plate shape, and an inorganic material layer situated over either or both of opposite principal surfaces of the porous base material; and an organic support over which the separator is laminated.

### TECHNICAL FIELD

The present invention relates to a multilayer body for a battery, and a method for producing a multilayer body for a battery.

### BACKGROUND ART

Nonaqueous electrolyte secondary batteries such as lithium ion secondary batteries are widely used as power sources of portable electronic devices such as portable terminals, portable phones, and laptop personal computers, and of electric-powered vehicles such as electric cars. In a nonaqueous electrolyte secondary battery, a separator made of a polymeric porous membrane is typically situated between a positive electrode and a negative electrode.

The separator is impregnated with an electrolytic solution to secure conductivity across the pair of electrodes, and also separates the electrodes from each other to inhibit short-circuiting across the electrodes. The separator also has a shutdown function of the separator itself melting to become free of pores when the interior of the battery has reached a high temperature due to some abnormality. The shutdown function, which gets the conductivity lost from inside the battery, ensures safety of the nonaqueous electrolyte secondary battery.

As nonaqueous electrolyte secondary batteries become popular, various methods are studied in order to further increase the safety of the nonaqueous electrolyte secondary batteries. In a lithium ion secondary battery disclosed as such a method and including a positive electrode, a negative electrode, and a separator situated between the positive electrode and the negative electrode, for example, the separator includes a resin layer and a porous metal layer imparted to a surface of the resin layer facing the negative electrode (for example, see Patent Document 1). The separator of Patent Document 1 secures a conductive state between the separator and the negative electrode by having a porous metal layer thickness of 1 μm or less, so that a charging-discharging property can be exhibited.

### CITATION LIST

### Patent Document

[Patent Document 1] Japanese Unexamined Patent Application Publication No. 2011-222215

### SUMMARY OF INVENTION

### Problem to be Solved by Invention

However, in the lithium ion secondary battery of Patent Document 1, the resin layer forming the separator is porous and has a thickness of some tens of micrometers. Hence, the resin layer has a low stiffness and is very difficult to handle. Therefore, when producing the separator by forming the porous metal layer over the resin layer, the surface of the resin layer tends to be, for example, wrinkled or broken. Hence, there is a problem that it is difficult to uniformly impart, for example, the metal layer over the surface of the resin layer.

When a separator having a nonuniform surface is applied to a nonaqueous electrolyte secondary battery, current flows tend to vary and become unstable. This may reduce the charging-discharging property of the nonaqueous electrolyte secondary battery and shorten the lifetime of the nonaqueous electrolyte secondary battery.

According to an embodiment of the present invention, it is an object to provide a multilayer body for a battery, the multilayer body being able to improve the uniformity of a surface of a separator.

### Means for Solving Problem

An embodiment of a multilayer body for a battery according to the present invention includes: a separator including a porous base material formed in a plate shape, and an inorganic material layer situated over either or both of opposite principal surfaces of the porous base material; and an organic support over which the separator is laminated.

An embodiment of a method for producing a multilayer body for battery separators according to the present invention is a method for producing the multilayer body for a battery described above, and includes: laminating a porous base material over an organic support to form a porous film; and forming an inorganic material layer over a principal surface of the porous film on a side of the porous base material by a sputtering method while conveying the porous film in a roll-to-roll manner.

### Advantageous Effects of Invention

An embodiment of a multilayer body for a battery according to the present invention can improve the uniformity of a surface of a separator over the multilayer body for a battery.

### BRIEF DESCRIPTION OF DRAWINGS

FIG. 1 is a schematic cross-sectional view illustrating the configuration of a multilayer body for a battery according to an embodiment of the present invention.

FIG. 2 is a diagram indicating the results of measurement of the width direction and the sheet resistance of test pieces of Example 1 and Example 14.

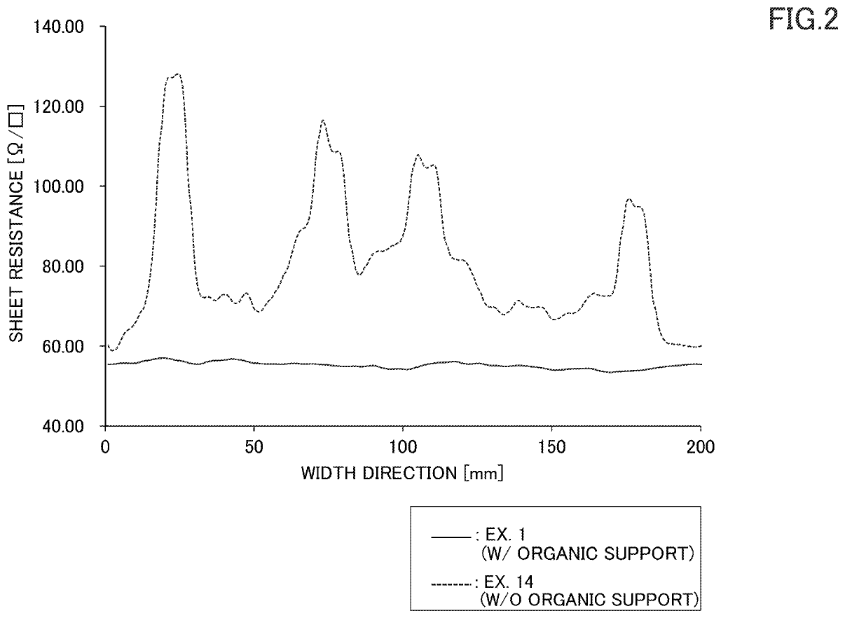

### DESCRIPTION OF EMBODIMENTS

Embodiments of the present invention will be described in detail below. For facilitating understanding of the description, the same components in the drawings will be denoted by the same reference numerals, and overlapping descriptions of the same components will be omitted. The components in the drawings may not be to scale. In the present specification, the term “through” indicating numerical ranges mean to include the values specified before and after the term “through” as the lower limit value and the upper limit value, unless otherwise specified.

### <Multilayer Body for a Battery>

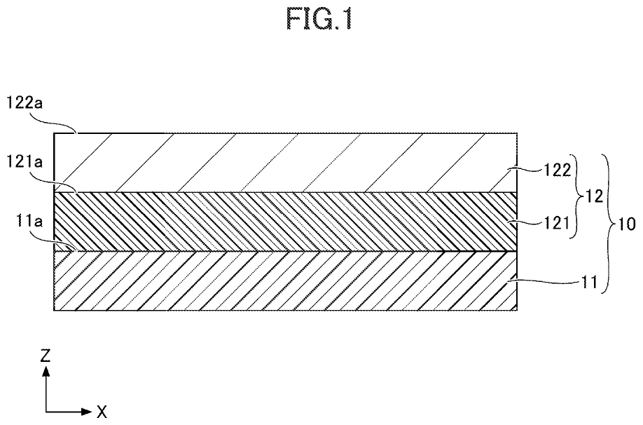

A multilayer body for a battery according to an embodiment of the present invention will be described. FIG. 1 is a schematic cross-sectional view illustrating the configuration of a multilayer body for a battery according to the present embodiment. As illustrated in FIG. 1, a multilayer body 10 for a battery according to the present embodiment includes an organic support 11 and a separator 12, and includes the separator 12 in a state of being laminated over an upper surface 11a of the organic support 11. The multilayer body 10 for a battery is formed in a sheet shape or a plate shape.

In the present specification, the direction of the thickness (vertical direction) of the multilayer body 10 for a battery is described as a Z-axis direction, and a lateral direction (horizontal direction) orthogonal to the direction of the thickness is described as an X-axis direction. The separator 12 side in the Z-axis direction is described as a +Z-axis direction, and the organic support 11 side in the Z-axis direction is described as a −Z-axis direction. In the following description, for expediency of description, the +Z-axis direction is described as upper or upper side, and the −Z-axis direction is described as lower or lower side. However, these terms do not represent the universal relationship regarding the height.

### [Organic Support]

The organic support 11 is a plate-shaped member or a film having opposite two principal surfaces, and the separator 12 is situated over the organic support 11. A lower surface of a porous base material 121 is situated to contact the upper surface (principal surface) 11a of the organic support 11.

Examples of the material of the organic support 11 include: polyolefins such as polyethylene (PE), polypropylene (PP), polybutylene (PB), and polypentene; polyesters such as polyethylene terephthalate (PET) and polyethylene naphthalate (PEN); acrylics such as polycarbonate (PC) and polymethyl methacrylate (PMMA); and cyclic polyolefins, triacetyl cellulose (TAC), polyether sulfide (PES), polyether ketone, polyether ether ketone, and polyimide. Among these materials, PE, PP, and PET are preferable in terms of maintaining durability during sputtering (sputter).

For example, mat finishing or a corona treatment may be applied to the surface of the organic support 11 to be joined to the porous base material 121.

The organic support 11 may include a tack layer over at least the side of the upper surface 11a to which the porous base material 121 is joined. Examples of a tackifier used for forming the tack layer include acrylic resins, alkyd resins, polyolefin resins, urethane resins, silicone resins, and rubber-based resins. These may be used alone or in combination of two or more.

Examples of the rubber-based resins include: diene-based rubbers such as natural rubbers, polyisoprene rubbers, polybutadiene rubbers, styrene/butadiene copolymer rubbers, butyl rubbers, butadiene/acrylonitrile copolymer rubbers, chloroprene rubbers, epoxidized natural rubbers, and hydrogenated natural rubbers; and non-diene-based rubbers such as butyl rubbers, ethylene/propylene rubbers, ethylene/propylene/diene rubbers, urethane rubbers, silicone rubbers, fluoro-rubbers, acrylic rubbers, polysulfide rubbers, and epichlorohydrin rubbers.

It is possible to form the tack layer by, for example, applying a solution containing the tackifier over at least the upper surface 11a of the organic support 11, and drying it. As the organic support over which such a tack layer is formed (a tack layer-added organic support), commercially available products such as RB100S, RB200S, R200, RB300S, R50ED, 3641FK2-1, P367K, 3641FK2, and 3642FK2 (all available from Nitto Denko Corporation) may be used.

The thickness of the organic support 11 is not particularly limited, yet is preferably in a range of from 20 μm through 200 μm, more preferably in a range of from 30 μm through 150 μm, and yet more preferably in a range of from 40 μm through 120 μm. When the organic support 11 includes the tack layer, it is preferable that the total thickness of the organic support 11 and the tack layer is in the range specified above.

The peel force of the organic support 11 is measured as a peel force (peel strength) in a peel test performed at a tensile speed of 300 mm/minute at a peel angle of 180°, using the porous base material 121 of the separator 12 as an adherent body adhering to the organic support 11. Unless otherwise particularly specified, the peel force is a measured value at 25° C. The peel force of the organic support 11 when peeling the organic support 11 from the porous base material 121 in the 180° peel test is higher than 0 N/cm, preferably 0.2 N/cm or lower, more preferably from 0.0001 N/cm through 0.18 N/cm, and yet more preferably from 0.005 N/cm through 0.15 N/cm. When the peel force is in the preferable range specified above, it is possible to maintain close adhesion between the organic support 11 and the porous base material 121, and to reduce damage on the porous base material 121 when peeling the organic support 11 from the separator 12.

### [Separator]

The separator 12 is situated by being laminated over the upper surface 11a of the organic support 11. The separator 12 includes the porous base material 121 and an inorganic material layer 122, and includes the inorganic material layer 122 in a state of being laminated over an upper surface (principal surface) 121a of the porous base material 121.

### (Porous Base Material)

The porous base material 121 is a porous membrane (porous film), and is formed in a plate shape (film shape). The porous base material 121 includes a base material main body, and an adhesive porous layer or adhesive porous layers formed over one surface (principal surface) of, or both of opposite surfaces (opposite principal surfaces) of the base material main body.

### ((Base Material Main Body))

The base material main body contains vacancies and voids in the interior. Examples of the base material main body include: a porous membrane; a porous sheet made of a fibrous material, such as a nonwoven cloth and paper; and a complex porous sheet including a porous membrane or a porous sheet and another or more porous layers laminated over the porous membrane or the porous sheet. In the present embodiment, a porous membrane is preferable in order to make the porous base material 121 thin and in terms of the strength of the porous base material 121. A porous membrane is a membrane having a structure including multiple pores in the interior, the pores being mutually linked so that a gas or a liquid can pass from one surface to an opposite surface of the membrane.

As the material of the base material main body, a material having an electrical insulating property is preferable. Organic materials and inorganic materials are both acceptable.

It is preferable that the base material main body contains a thermoplastic resin, because a thermoplastic resin has a shutdown function. The shutdown function is a function of shutting off migration of ions across electrodes by the constituent material of the base material main body dissolving and blocking the pores in the base material main body when the battery temperature has hiked, to inhibit thermal runaway of the battery.

As the thermoplastic resin, a thermoplastic resin having a melting point lower than 200° C. is preferable. Examples of the thermoplastic resin include: polyolefins such as polyethylene (PE), polypropylene (PP), polybutylene (PB), and polypentene; and polyesters such as polyethylene terephthalate (PET). These thermoplastic resins may be used alone or in combination of two or more. Among these thermoplastic resins, polyolefins are preferable, polyethylene is more preferable in terms of the shutdown function, and it is yet more preferable that polyethylene and polypropylene are contained because they have the shutdown function and a heat resistance that does not easily let the membrane be torn when exposed to a high temperature. Polyethylene and polypropylene may coexist in one layer. In this case, for example, the content of polyethylene may be 95% by mass or greater and the content of polypropylene may be 5% by mass or less.

As the porous membrane, it is preferable to use a porous membrane containing a polyolefin (referred to as a polyolefin porous membrane). Any polyolefin porous membrane may be appropriately selected, and it is preferable to select one that has a sufficient ion permeability.

It is preferable that the polyolefin porous membrane contains polyethylene, because polyethylene exhibits the shutdown function. The content of polyethylene is preferably 95% by mass or greater relative to the mass of the entire polyolefin porous membrane.

It is preferable that the polyolefin porous membrane contains polypropylene, because polypropylene has a heat resistance that does not easily let the membrane be torn when exposed to a high temperature.

In terms of satisfying both of the shutdown function and heat resistance, the polyolefin porous membrane may include a layer containing polyethylene and a layer containing polypropylene, and may have a two or more-layered multilayered structure in which these layers are laminated.

The weight average molecular weight (Mw) of polyolefin to be contained in the polyolefin porous membrane is preferably, for example, from 100,000 through 5,000, 000 in order for the membrane to have a sufficient mechanical property and a good shutdown property, and in terms of ease of molding.

An example of the method for producing the porous membrane will be described. Examples of the method include: a method of extruding a melted thermoplastic resin from a T-die into a sheet shape, crystallizing and stretching the obtained sheet, and subsequently thermally treating the resulting product, to produce a porous membrane; and a method of extruding a thermoplastic resin that is melted together with a plasticizer such as liquid paraffin from a T-die, cooling the resulting product, stretching the obtained gel-like sheet, washing the resulting product in a methylene chloride bath to extract the plasticizer, and subsequently thermally treating and drying the washed sheet, to produce a porous membrane.

As the porous sheet, it is preferable to use: polyolefins such as polyethylene (PE) and polypropylene (PP); heat-resistant resins such as wholly aromatic polyamide, polyamide imide (PAI), polyimide (PI), polyether sulfone (PES), polysulfone (PSU), polyether ketone (PEK), and polyether imide (PEI); and fibrous materials such as cellulose.

Examples of the complex porous sheet include a complex sheet obtained by laminating a functional layer over a porous membrane or a porous sheet. The complex porous sheet is preferable because the functional layer can add an additional function. In terms of imparting heat resistance, examples of the functional layer include: a porous layer made of a heat-resistant resin; and a porous layer made of a heat-resistant resin and an inorganic filler.

Examples of the heat-resistant resin include wholly aromatic polyamide (wholly aromatic PA), polyamide imide (PAI), polyimide (PI), polyether sulfone (PES), polysulfone (PAI), polyether ketone (PEK), and polyether imide (PEI). These heat-resistant resins may be used alone or in combination or two or more.

Examples of the inorganic filler include: metal oxides such as alumina; and metal hydroxides such as magnesium hydroxide.

Examples of the complex producing method include a method of applying a functional layer over a porous membrane or a porous sheet by coating, a method of bonding a porous membrane or a porous sheet and a functional layer with each other with an adhesive, and a method of bonding a porous membrane or a porous sheet and a functional layer with each other by thermal compression bonding.

In order to have an improved wettability with a coating liquid for forming the adhesive porous layer, the surface of the base material main body may optionally be subjected to various surface treatments such as a corona treatment, a plasma treatment, a flame treatment, and an ultraviolet irradiation treatment to an extent that the base material main body does not lose its property.

The thickness of the base material main body may be appropriately selected, and is preferably from 3 μm through 25 μm, more preferably from 5 μm through 20 μm, and yet more preferably from 7 μm through 15 μm in order to increase the energy density of a nonaqueous electrolyte secondary battery when the multilayer body 10 for a battery is applied to the nonaqueous electrolyte secondary battery, and in terms of the production yields of the multilayer body 10 for a battery and of nonaqueous electrolyte secondary batteries when the multilayer body 10 for a battery is applied to nonaqueous electrolyte secondary batteries.

In the present specification, the thickness of the base material main body is a length of the base material main body in a direction perpendicular to the principal surfaces of the base material main body. The thickness of the base material main body may be, for example, a thickness measured at a desirably selected location in a cross-section of the base material main body, or may be an average of measurements obtained at more than one desirably selected locations. In the following description, the thickness will be defined the same for any other members.

The Gurley value (Japanese Industrial Standards (JIS) P8117: 2009) of the base material main body is preferably from 50 seconds/100 mL through 300 seconds/100 mL in terms of ion permeability or mitigation of short-circuiting in a nonaqueous electrolyte secondary battery when the multilayer body 10 for a battery is applied to the nonaqueous electrolyte secondary battery.

The voidage of the base material main body is preferably from 20% through 80%, more preferably from 25% through 65%, and yet more preferably from 30% through 55%. When the voidage of the base material main body is in the preferable range specified above, the multilayer body 10 for a battery has a good air permeance, can flow a high current by inhibiting increase in electrical resistance due to the base material main body, and can also have a sufficient mechanical strength. The voidage is a percentage (% by volume) at which void portions occupies the base material main body.

The puncture strength of the base material main body is preferably 300 g or greater in terms of the production yield of the multilayer body 10 for a battery and the production yield of nonaqueous electrolyte secondary batteries when the multilayer body 10 for a battery is applied to nonaqueous electrolyte secondary batteries. The puncture strength of the base material main body is, for example, the maximum puncture load (unit: g) measured in a puncture test performed using a compression tester under conditions including a needle tip curvature radius of 0.5 mm and a puncture rate of 2 mm/second.

### ((Adhesive Porous Layer))

The adhesive porous layer is a layer formed over at least one principal surface of the base material main body, and may be formed over only one surface of, or both of opposite surfaces of the base material main body. The adhesive porous layer may have a function for increasing the strength of the multilayer body 10 for a battery, may have a function for binding the base material main body with an electrode, or may have both of these functions at the same time. The adhesive porous layer is a layer to be bonded with an electrode when applying the multilayer body 10 for a battery to a nonaqueous electrolyte secondary battery and overlaying the multilayer body 10 for a battery and the electrode over each other. The adhesive porous layer has a structure including multiple pores in the interior, the pores being mutually linked so that a gas or a liquid can pass from one surface to an opposite surface of the layer.

The adhesive porous layer may be provided over only one surface of the porous base material or over both of opposite surfaces of the porous base material. When adhesive porous layers are provided over both of opposite surfaces of the porous base material, the multilayer body 10 for a battery can bond with both poles of a nonaqueous electrolyte secondary battery favorably, when the multilayer body 10 for a battery is applied to the nonaqueous electrolyte secondary battery. Moreover, the multilayer body 10 for a battery does not readily curl, and can be handled well during production of a nonaqueous electrolyte secondary battery. When an adhesive porous layer is provided over only one surface of the base material main body, the multilayer body 10 for a battery has a better ion permeability. Moreover, the thickness of the entire multilayer body 10 for a battery can be reduced, and it is possible to produce a nonaqueous electrolyte secondary battery having a higher energy density.

As the material for forming the adhesive porous layer, an adhesive resin can be used. Examples of the adhesive resin include polyvinylidene fluoride (PVDF), vinylidene fluoride/hexafluoropropylene copolymers, vinylidene fluoride/trichloroethylene copolymers, polyimide, polymethyl methacrylate, polybutyl acrylate, polyacrylonitrile, polyvinyl pyrrolidone, polyvinyl acetate, ethylene/vinyl acetate copolymers, polyethylene oxide, polyamide imide, polyimide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, and carboxymethyl cellulose. Among these adhesive resins, either or both of fluorine atom-containing resins and acrylic resins are preferable, and polyvinylidene fluoride (PVDF) is particularly preferable. These resins may be used alone or in combination of two or more.

The amount of a vinylidene fluoride copolymer in the adhesive porous layer is preferably from 10% by mass through 100% by mass. When the amount of a vinylidene fluoride copolymer is in the range specified above, the resin layer and the base material main body tend to have an increased adhesiveness, the resin layer and an electrode tend to have an increased adhesiveness, the multilayer body 10 for a battery tends to have an increased strength, and the resin layer itself tends to have an increased strength. The thickness of the resin layer is appropriately selected in accordance with the function of the resin layer and is not particularly limited.

The adhesive porous layer may contain a filler in addition to the adhesive resin. As the filler, either or both of inorganic particles and organic particles are more preferable. The inorganic particles are not particularly limited, and examples of the inorganic particles include calcium carbonate, calcium phosphate, amorphous silica, crystalline glass fillers, kaolin, talc, titanium dioxide, alumina, boehmite, silica-alumina complex oxide particles, barium sulfate, calcium fluoride, lithium fluoride, zeolite, molybdenum sulfide, and mica. Examples of the organic particles include heat-resistant cross-linked polymer particles. Examples of the heat-resistant cross-linked polymer particles include cross-linked polystyrene particles, cross-linked acrylic particles, and cross-linked methyl methacrylate particles. Examples of the shape of the inorganic particles and the organic particles include a true spherical shape, an approximately spherical shape, a plate shape, an acicular shape, and a polyhedral shape. The shape of the inorganic particles and the organic particles is not particularly limited.

By containing a filler, the adhesive porous layer can inhibit internal short-circuiting due to growth of a dendritic crystal (dendrite) from an electrode, when the multilayer body 10 for a battery is applied to a nonaqueous electrolyte secondary battery. Hence, it is possible to inhibit thermal runaway that is due to internal short-circuiting in the nonaqueous electrolyte secondary battery, and that may shrink the porous base material (particularly, a polyolefin porous membrane). These fillers may be used alone or in combination of two or more. The content of the filler in the adhesive porous layer is preferably from 10% by volume through 99% by volume, more preferably from 20% by volume through 90% by volume, and yet more preferably from 30% by volume through 80% by volume. When the content of the filler in the adhesive porous layer is in the preferable range specified above, it is possible to effectively inhibit occurrence of a dendrite, or to inhibit thermal runaway that may shrink a polyolefin porous base material.

As the porous base material 121, it is preferable to use a multilayer body in which PE is used as the base material main body, PVDF is used as the adhesive porous layer, and PVDF, PE, and PVDF are laminated in this order.

The method for forming the adhesive porous layer is not particularly limited. For example, it is possible to use a method of applying a coating liquid containing the adhesive resin and a solvent (dispersion medium) over a surface of the base material main body, and drying the solvent, to form the adhesive porous layer. For example, the coating liquid is prepared by dissolving or dispersing the adhesive resin in the solvent. Examples of the method for applying the coating liquid over a surface of the base material main body include common publicly-known coating methods. As such a coating method, for example, a dip coating method, a wire bar method, a gravure coating method, a kiss method, a die coating method, a roll coating method, and a comma coating method can be used.

When the coating liquid is applied over one or both of opposite surfaces of the base material main body (porous film) and the base material main body is subsequently immersed in a water-based solvent, the applied resin solidifies in a three-dimensional network-like shape. In this way, the adhesive porous layer is formed. The water-based solvent is a solvent containing water, which is a poor solvent for the resin. Examples of the solvent that can coexist with water include alcohols, acetone, and N-methyl-2-pyrrolidone. After formed over a surface of the base material main body, the adhesive porous layer is dried in a heating furnace. The drying temperature in the heating furnace is preferably in a range of from 40° C. through 100° C. The heating furnace passing time is appropriately adjusted in accordance with the temperature in the heating furnace, yet is preferably in a range of from 40 seconds through 120 seconds. The film tension during conveying is preferably in a range of from 3 MPa through 10 MPa.

When drying the adhesive porous layer, it is preferable that the adhesive porous layer is dried to an extent that at least part of the solvent (dispersion medium) in the adhesive porous layer can be removed. Drying may be performed a plurality of times at different temperatures, and pressure may be applied during drying. Drying may further be followed by thermal treatment For example, the drying temperature is preferably from 40° C. through 150° C. and more preferably from 45° C. through 130° C., and the drying time may be from 1 minute through 15 hours.

The thickness of the adhesive porous layer is preferably from 0.05 μm through 3 μm, and more preferably from 0.1 μm through 2.5 μm. When the thickness of the adhesive porous layer is in the preferable range specified above, the film resistance of the multilayer body 10 for a battery can be inhibited to a low level, and the multilayer body 10 can have a good adhesiveness with an electrode and can maintain a mechanical strength when applied to a nonaqueous electrolyte secondary battery.

### (Inorganic Material Layer)

As illustrated in FIG. 1, the inorganic material layer 122 is situated over an upper surface 121a of the porous base material 121. The inorganic material layer 122 may be situated over both of opposite surfaces (both of opposite principal surfaces) of the porous base material 121.

As the material for forming the inorganic material layer 122, for example, Cu, Al, C, Sn, Si, Bi, Ag, Au, and oxides and oxynitrides thereof may be used. Among these materials, Cu, Al, and C are preferable because they are low-cost and can be easily handled. These materials may be used alone or in combination of two or more. When using two or more materials in combination, the inorganic material layer 122 may contain two or more materials in a mixed state obtained by a multi-sputtering method, or two or more inorganic material layers 122 containing different materials may be laminated by a single sputtering method.

The thickness of the inorganic material layer 122 may be appropriately set, and is preferably, for example, from 1 nm through 1 μm, preferably from 3 nm through 800 nm, and preferably from 10 nm through 600 nm. When the thickness of the inorganic material layer 122 is in the preferable range specified above, a nonaqueous electrolytic solution can pass through the separator 12 when the separator 12 is applied to a nonaqueous electrolyte secondary battery, and it is possible to inhibit: increase in the mass of the multilayer body 10 for a battery; and reduction in the handleability of the multilayer body 10 for a battery. When the thickness of the inorganic material layer 122 is in the preferable range specified above, the inorganic material layer 122 can reliably have conductivity when it is a metal layer, and it is possible to reduce occurrence of cracks in the interior or the surface of the inorganic material layer 122 when the inorganic material layer 122 is handled.

The thickness of the separator 12 is preferably from twice through 5 times, and more preferably from 2.5 times through 4 times as large as the thickness of the organic support 11. When the sum of the thicknesses of the porous base material 121 and the inorganic material layer 122 is in the preferable range specified above, it is easier to maintain the strength of the multilayer body 10 for a battery, and it is possible to maintain the organic support 11 and the porous base material 121 in a joined state.

An example of the method for producing the multilayer body 10 for a battery will be described.

The method for producing the multilayer body 10 for a battery includes: laminating the porous base material 121 over the organic support 11 to form a complex body; and forming the inorganic material layer 122 over a principal surface of the complex body on the porous base material 121 side by a sputtering method while conveying the complex body in a roll-to-roll manner, to form the separator 12.

In the method for producing the multilayer body 10 for a battery, a complex body is formed by pasting the porous base material 121 over the upper surface 11a of the organic support 11. The method for laminating the organic support 11 and the porous base material 121 over each other needs only to be a method that can paste the organic support 11 and the porous base material 121 with each other. For example, the organic support 11 and the porous base material 121 that are wound on, for example, different unwinding rolls are unwound, such that the porous base material 121 is pasted over the upper surface 11a of the organic support 11 to obtain a complex body, which is then taken up on a take-up roll.

Next, the inorganic material layer 122 is formed over the upper surface 121a, which is one surface of the porous base material 121 of the complex body taken up on the unwinding roll. The method for forming the inorganic material layer 122 may be, for example, a dry process. The dry process may be, for example, sputtering or vacuum vapor deposition. As the method for forming the inorganic material layer 122, a dry process is preferable in terms of forming the inorganic material layer 122 to be thin, and sputtering is more preferable in terms of making the density of the inorganic material layer 122 high.

When employing sputtering, for example, the complex body taken up on the unwinding roll is set in a thin film formation apparatus. While the complex body is being conveyed in a roll-to-roll (R-to-R) manner, the inorganic material layer 122 is formed over the upper surface 121a of the porous base material 121 by a sputtering method. In this way, the multilayer body 10 for a battery is obtained.

As the thin film formation apparatus, a R-to-R sputtering apparatus is used. The R-to-R sputtering apparatus is configured to form the inorganic material layer 122 containing a metal by sputtering the metal onto the upper surface 121a of the porous base material 121 by the R-to-R method. Here, as the process gas, Ar gas is supplied into the apparatus to bring about an Ar gas atmosphere in the apparatus. A plurality of targets can be set in the R-to-R sputtering apparatus. Hence, once the unwinding roll is set, a plurality of different metals can be deposited while the interior of the apparatus is maintained in the Ar gas atmosphere.

As a target, a target of a metal that is to be contained in the inorganic material layer 122 may be used. As the target of the metal, a target containing Cu, C, Sn, Al, Si, Bi, Ag, or Au may be used.

When the inorganic material layer 122 contains a metal oxide of Cu, C, Sn, Al, Si, Bi, Ag, or Au, an oxygen gas is supplied into the R-to-R sputtering apparatus in addition to the Ar gas as the process gas. Hence, a metal oxide of the target material can be deposited over the upper surface 121a of the porous base material 121.

During formation of the inorganic material layer 122, for example, the Ar flow rate, and the pressure in the gas atmosphere when performing sputtering may be appropriately set.

When employing a dry process such as sputtering or vacuum vapor deposition for forming the inorganic material layer 122, it is preferable to cool a table on which the organic support 11 and the porous base material 121 are set to, for example 0° C. or lower. When forming the inorganic material layer 122 by employing, for example, sputtering or and vacuum vapor deposition, the organic support 11 and the porous base material 121 may be damaged because a high-temperature thermal load is applied to the organic support 11 and the porous base material 121 when the inorganic material layer 122 is formed thereover. Hence, when forming the inorganic material layer 122 by employing, for example, sputtering or vacuum vapor deposition, cooling the organic support 11 and the porous base material 121 by cooling the table on which the organic support 11 and the porous base material 11 are set makes it possible to form the inorganic material layer 122 while maintaining the durability of the organic support 11 and the porous base material 121.

In the method for producing the multilayer body 10 for a battery, supporting the porous base material 121 on the organic support 11 can inhibit deformation of the porous base material 12 by means of the organic support 11. Hence, by handling the porous base material 121 together with the organic support 11, it becomes easier to handle the porous base material 121. Hence, the porous base material 121 can be inhibited from being wrinkled or broken during handling. When forming the inorganic material layer 122 over the porous base material 121, the inorganic material layer 122 is laminated to conform to the irregularities of the upper surface (principal surface) 121a of the porous base material 121. Hence, by inhibiting irregularities of the upper surface 121a of the porous base material 121, it is possible to inhibit irregularities from being formed in an upper surface (principal surface) 122a of the inorganic material layer 122, and to increase the uniformity of the upper surface 122a of the inorganic material layer 122. Hence, the multilayer body 10 for a battery can improve the uniformity of the principal surface of the separator 12.

As described, the multilayer body 10 for a battery includes the organic support 11, and the separator 12 including the porous base material 121 and the inorganic material layer 122 in a state of being laminated in this order. As the porous base material 121 is laminated over the upper surface 11a of the organic support 11, deformation of the porous base material 121 is inhibited by the organic support 11. Hence, by handling the porous base material 121 together with the organic support 11, it is possible to inhibit the porous base material 121 from being wrinkled or broken. Hence, the upper surface 122a of the inorganic material layer 122 laminated over the upper surface 121a of the porous base material 121 is inhibited from having irregularities conforming to the irregularities of the upper surface 121a of the porous base material 121, and the uniformity of the upper surface 122a of the inorganic material layer 122 can be improved. Hence, the multilayer body 10 for a battery can improve the uniformity of the principal surface of the separator 12.

When the multilayer body 10 for a battery is applied to a nonaqueous electrolyte secondary battery and the organic support 11 is peeled from the separator 12, the separator 12 can be used with its surface maintained in the highly uniform state. Hence, the separator 12 can be inhibited from having resistance variation in the inorganic material layer 122. As the inorganic material layer 122 is thicker, the inorganic material layer 122 has a lower resistance. As the inorganic material layer 122 is thinner, the inorganic material layer 122 has a higher resistance. Resistance variation in the inorganic material layer 122 is affected by surface irregularities of the upper surface 122a thereof. As the upper surface (principal surface) 112a of the inorganic material layer 122 has a higher uniformity and is flatter, resistance variation in the principal surface 112a of the inorganic material layer 122 is better restricted. Hence, when the separator 12 is used on a nonaqueous electrolyte secondary battery, the highly uniform principal surface 112a of the inorganic material layer 122 can restrict resistance variation in the inorganic material layer 122. Restricted resistance variation in the inorganic material layer 122 makes it difficult for any variation to occur in the flows of currents when the currents flow, and facilitates stable flows of the currents. Hence, it is possible to sustain the charging-discharging property of the nonaqueous electrolyte secondary battery, and to inhibit shortening of the lifetime.

Any resistance variation in the inorganic material layer 122 of the separator 12 can be evaluated based on dispersions of a plurality of resistance values from their average, the plurality of resistances being measured on the surface of the multilayer body 10 for a battery on the inorganic material layer 122 side using a non-contact resistance measuring instrument according to an eddy current measuring method based on JIS Z 2316-1: 2014. For example, measurements are obtained from a plurality of positions of the separator 12 that are between one end and the other end of the separator 12 in the direction of the width or the direction of the length of the separator 12, and resistance variation in the inorganic material layer 122 can be evaluated based on the dispersions of the plurality of resistance values from the average of the resistance values.

In the multilayer body 10 for a battery, the peel force to peel the organic support 11 from the porous base material 121 in the 180° peel test can be higher than 0 N/cm and 0.2 N/cm or lower. Hence, in the multilayer body 10 for a battery in which the peel force to peel the organic support 11 from the porous base material 121 is in the predetermined range, the porous base material 121 and the organic support 11 can maintain close adhesiveness, and the organic support 11 can be peeled from the separator 12 with reduced application of damage to the porous base material 121 during peeling. Hence, when the organic support 11 is peeled from the multilayer body 10 for a battery for use, the separator 12 can have a high smoothness on both of the lower surface of the porous base material 121 and the upper surface 122a of the inorganic material layer 122.

It is possible to evaluate any damage on the porous base material 121 that may be due to peeling the organic support 11 from the separator 12, by observing the interface between the organic support 11 and the porous base material 121 after the 180° peel test, and observing the degree of adherence of the outermost layer of the porous base material such as a PVDF layer to the interface of the organic support. For example, when the porous base material 121 includes a PVDF layer as the outermost layer and the PVDF layer has remained adhering to the organic support 11, the portions on the interface of the organic support at which the PVDF layer has remained adhering become white because the PVDF layer is white. Hence, the surface of the porous base material is determined as being damaged as much as the white portions.

In the multilayer body 10 for a battery, the thickness of the inorganic material layer 122 can be from 1 nm through 1 μm. Hence, the inorganic material layer 122 can have a high strength and a high stiffness. Hence, it is possible to reduce occurrence of breakage such as cracks in the inorganic material layer 122 and to make the inorganic material layer 122 less likely to be deformed when peeling the separator 12 from the organic support 11. Hence, the separator 12 can maintain surface uniformity and have an improved durability. Hence, when the separator 12 is applied to a nonaqueous electrolyte secondary battery, the nonaqueous electrolyte secondary battery can sustain, for example, the charging-discharging property, and can be inhibited from durability reduction.

In the multilayer body 10 for a battery, the inorganic material 122 can contain one or more components selected from the group consisting of Cu, C, Sn, Al, Si, Bi, Ag, and Au. Hence, because it is easy to form the inorganic material layer 122 and the inorganic material layer 122 has a good conductivity, it is easy to produce the multilayer body 10 for a battery, and a nonaqueous electrolyte secondary battery can be stably charged or discharged when the multilayer body 10 for a battery is applied to the nonaqueous electrolyte secondary battery.

In the multilayer body 10 for a battery, the porous base material 121 may be a laminate including PVDF, PE, and PVDF in the state of being laminated in this order. Hence, in the multilayer body 10 for a battery, the porous base material 121 can have an increased strength and tackiness. Hence, the porous base material 121 can have a close adhesiveness with the inorganic material layer 122 while sustaining its durability.

In the multilayer body 10 for a battery, the thickness of the separator 12 can be from twice through 5 times as large as the thickness of the organic support 11. Hence, the multilayer body 10 for a battery can have a high strength because the inorganic material layer 122 can have an increased strength.

Because the multilayer body 10 for a battery can increase the uniformity of the principal surface 112a of the separator 12 as described above, the multilayer body 10 for a battery can be effectively used for a nonaqueous electrolyte secondary battery separator of a nonaqueous electrolyte secondary battery. Examples of the nonaqueous electrolyte secondary battery include a lithium ion secondary battery, a nickel-hydrogen secondary battery, a nickel-cadmium secondary battery, and a polymer secondary battery. The multilayer body 10 for a battery can be effectively used for a lithium ion secondary battery separator of a lithium ion secondary battery among these secondary batteries. By the multilayer body 10 for a battery being used for a separator of a nonaqueous electrolyte secondary battery, the nonaqueous electrolyte secondary battery can sustain its charging-discharging property longer. Hence, a nonaqueous electrolyte secondary battery according to the present embodiment can prolong its serviceable period while being inhibited from reduction in the charging-discharging property. Hence, since the nonaqueous electrolyte secondary battery employing the separator 12 of the multilayer body 10 for a battery has such a property as described above, it can be favorably used on portable electronic devices such as portable terminals, portable phones, and laptop personal computers, and electric-powered vehicles such as electric vehicles (EV), hybrid vehicles (HV), and plug-in hybrid vehicles (PHV).

### EXAMPLES

The embodiment will be more specifically described by way of Examples. The embodiment should not be construed as being limited by these Examples. Example 1 to Example 13 are Examples, and Example 14 is a Comparative Example.

### <Production of Multilayer Body for a Battery>

### Example 1

### (Pasting of Organic Support and Porous Base Material)

Using a laminator, a porous base material 1 (a PVDF/PE/PVDF three-layered resin porous film, having a thickness of 16 μm and a width of 200 mm), which was wound on an unwinding roll, was pasted over an organic support 1 (a tack layer-added resin film (R200, obtained from Nitto Denko Corporation), having a width of 200 mm), which was wound on another unwinding roll, to produce a complex body, and the produced complex body was taken up on a take-up roll.

### (Formation of Inorganic Material Layer)

Next, the take-up roll on which the complex body was taken up, and a copper target were mounted on an R-to-R sputtering apparatus. While the complex body was conveyed from the take-up roll to be taken up on a drum roll cooled to −10° C., the degree of vacuum in the atmosphere in the apparatus was set to 1×10-5 Pa, using a cryocoil and a turbopump. Subsequently, with the vacuum maintained, Cu was sputtered onto a surface of the complex body on the porous base material 1 side by a sputtering method, from the copper target that was previously set on an electrode in the apparatus, to form a Cu film, while supplying an argon gas into the apparatus as the process gas during sputtering. In this way, a Cu film, which was an inorganic material layer having a thickness of 10 nm, was formed. The conveying speed of the complex body was adjusted such that the thickness of the Cu film would be 10 nm. By the Cu film being formed over the porous base material 1 of the complex body, a multilayer body for a battery was produced.

### (Peel Force of Organic Support)

The multilayer body for a battery was prepared as a test piece having a size of 10 mm in width and 100 mm in length. Subsequently, a cutter was inserted into the interface between the separator and the organic support of the test piece, to peel one end of the organic support in the longer direction from the separator. The organic support was set such that, of the ends of the organic support in the longer direction, the one end that was peeled from the separator came to the lower side. Then, a peel test was performed in an environment at 25° C., using a universal tensile compression tester (“desktop precision universal tester autograph, AGS-50NX” obtained from SHIMADUZ Corporation) under conditions including a tensile speed of 300 mm/min and a peel angle of 180°, such that with the separator fixed, the peeling of the test piece or the peeling from the separator would advance from the lower side to the upper side. The peel force of the organic support when peeling the organic support from the porous base material was measured. The measurement was performed three times, and the average was adopted as the peel force [N/cm].

The type of the organic support, presence or absence of a tack layer over the organic support, and the peel force of the organic support, the type of the porous base material 1 and presence or absence of a PVDF layer over the porous base material 1, and the material and the thickness of the inorganic material layer are indicated in Table 1.

### Example 2 to Example 4

Multilayer bodies for batteries were produced in the same manner as in Example 1, except that unlike in Example 1, the organic support 1 was changed to any of an organic support 2 to an organic support 4 indicated in Table 1. In Example 4, the thickness of a tack layer over the organic support 1 used in Examples 12 and 13 described below was 5 μm.

### (Type of Organic Support)

Organic support 2: a tack layer-added resin film (RB300S, obtained from Nitto Denko Corporation)
Organic support 3: a tack layer-added resin film (R50ED, obtained from Nitto Denko Corporation)
Organic support 4: a tack layer-added resin film (3641FK2-1, obtained from Nitto Denko Corporation)

### Example 5

A multilayer body for a battery was produced in the same manner as in Example 1, except that unlike in Example 1, the type of the inorganic material layer was changed from Cu to Al.

### Example 6 to Example 8

Multilayer bodies for batteries were produced in the same manner as in Example 1, except that unlike in Example 1, the thickness of the inorganic material layer was changed to the thickness indicated in Table 1.

### Example 9

A multilayer body for a battery was produced in the same manner as in Example 1, except that unlike in Example 1, the organic support 1 was changed to an organic support 5, and a multilayer body including the organic support and a porous base material was produced by pasting the four corners of the porous base material, which was cut into an A4 size, over the organic support using a tack tape (Nitoflon No. 903UL, obtained from Nitto Denko Corporation).

### (Type of Organic Support)

Organic support 5: a tack layer-free resin film (a PET film (0300E, obtained from Mitsubishi Chemical Corporation), having a tack layer-free thickness of 125 μm)

### Example 10

A multilayer body for a battery was produced in the same manner as in Example 1, except that unlike in Example 1, the porous base material 1 was changed to a porous base material 2 (a PE film), and the porous base material 2 was fixed over the four corners of the organic support 1 using a tackifier (Nitoflon No. 903UL, obtained from Nitto Denko Corporation).

### Example 11 to Example 13

Multilayer bodies for batteries were produced in the same manner as in Example 1, except that unlike in Example 1, the organic support 1 was changed to any of organic supports 6 to 8.

### (Type of Organic Support)

Organic support 6: a tack layer-added resin film (P367K, obtained from Nitto Denko Corporation)
Organic support 7: a tack layer-added resin film (P3641FK2, obtained from Nitto Denko Corporation)
Organic support 8: a tack layer-added resin film (P3642FK2, obtained from Nitto Denko Corporation)

### Example 14

In Example 14, a multilayer body for a battery was produced in the same manner as in Example 1, except that the organic support 1 was not formed.

### <Evaluation of Properties>

As the properties of the multilayer bodies for batteries produced in the Examples, resistance variation in the multilayer body for a battery, close adhesiveness between the organic support and the separator, and the degree of damage on the separator were evaluated.

### [Resistance Variation]

The multilayer bodies for batteries produced in the Examples were used as test pieces (having a width of 200 mm). The sheet resistance of each test piece within its width (200 mm) was measured at 1 mm intervals along the width direction of the test piece, using a non-contact resistance measuring instrument (NC-80MAP, obtained from NAPSON Corporation) according to an eddy current measuring method based on JIS Z 2316-1: 2014. Based on the two-hundred measurement result data, the average value, the maximum value, and the minimum value of the sheet resistance were calculated, and the resistance variation in the test piece was evaluated according to the evaluation criteria described below. The grade A evaluation means that the multilayer body for a battery was good because the resistance variation in the inorganic material layer was small. The grade B evaluation means that the multilayer body for a battery was defective because the resistance variation in the inorganic material layer was large.

### (Evaluation Criteria)

A: The maximum value and the minimum value were both within 20% of the average value.
B: The maximum value and the minimum value were both outside 20% of the average value.

### [Close Adhesiveness Between Organic Support and Separator]

The peel force measured value of the organic support obtained in [Peel force of organic support] described above was evaluated according to the evaluation criteria described below as close adhesiveness between the organic support and the separator. The grade A evaluation means that the close adhesiveness between the organic support and the separator was a level at which no damage occurred or damage that would be nonproblematic for practical use occurred when the separator was peeled from the organic support. The grade B evaluation means that the close adhesiveness between the organic support and the separator was a level at which the separator was susceptible to damage when the separator was peeled from the organic support. The grade C evaluation means that when alone, the organic support was unable to have close adhesiveness with the separator.

### (Evaluation Criteria)

A: The peel force of the organic support was in a range of higher than 0 N/cm and 0.2 N/cm or lower.
B: The peel force of the organic support, although in a range of higher than 0 N/cm and 0.5 N/cm or lower, was higher than 0.2 N/cm.
C: The peel force of the organic support was 0 N/cm.

### [Degree of Damage on Separator]

The surface of the organic support when [Peel force of organic support] described above was measured was observed, to confirm the degree of adherence of the PVDF layer, which was the outermost layer of the porous base material, to the interface of the organic support, and evaluate the degree of damage on the separator according to the evaluation criteria described below. The grade A evaluation or the grade B evaluation means that the damage on the separator was a nonproblematic level for practical use. The grade C evaluation means that the damage on the separator was a problematic level for practical use. As the organic support was transparent and the PVDF layer was white, the portions on the interface of the organic support at which the PVDF layer would have remained adhering would become white. The surface of the porous base material would be evaluated as being damaged as much as any such white portions.

### (Evaluation Criteria)

A: Changes were observed on the surface of the organic support.
B: White cloudy dots were observed on part of the surface of the organic support.
C: White cloudy regions were observed on 30% or more of the surface of the organic support.

The results of evaluation on the multilayer bodies for batteries produced in the Examples regarding resistance variation, close adhesiveness between the organic support and the separator, and the degree of damage on the separator are indicated in Table 1.

TABLE 1

| | Organic support | | | Porous base material | | | | | | |
|---|---|---|---|---|---|---|---|---|---|---|
| | | Presence | | | Presence | Inorganic | | | Close | |
| | | or absence | Peel | | or absence | material layer | | | adhesiveness | Degree of |
| | | of tack | force | | of PVDF | | Thickness | Resistance | with | separator |
| | Type | layer | [N/cm] | Type | layer | Material | [nm] | distribution | separator | damage |
| Ex. 1 | Organic support 1 | Present | 0.0080 | Porous base material 1 | Present | Cu | 10 | A | A | A |
| Ex. 2 | Organic support 2 | Present | 0.0030 | Porous base material 1 | Present | Cu | 10 | A | A | A |
| Ex. 3 | Organic support 3 | Present | 0.0004 | Porous base material 1 | Present | Cu | 10 | A | A | A |
| Ex. 4 | Organic support 4 | Present | 0.1900 | Porous base material 1 | Present | Cu | 10 | A | A | A |
| Ex. 5 | Organic support 1 | Present | 0.0080 | Porous base material 1 | Present | Al | 10 | A | A | A |
| Ex. 6 | Organic support 1 | Present | 0.0080 | Porous base material 1 | Present | Cu | 30 | A | A | A |
| Ex. 7 | Organic support 1 | Present | 0.0080 | Porous base material 1 | Present | Cu | 50 | A | A | A |
| Ex. 8 | Organic support 1 | Present | 0.0080 | Porous base material 1 | Present | Cu | 100 | A | A | A |
| Ex. 9 | Organic support 5 | Absent | 0.0000 | Porous base material 1 | Present | Cu | 10 | A | C | A |
| Ex. 10 | Organic support 1 | Present | 0.0080 | Porous base material 2 | Absent | Cu | 10 | A | A | A |
| Ex. 11 | Organic support 6 | Present | 0.0000 | Porous base material 1 | Present | Cu | 10 | A | C | A |
| Ex. 12 | Organic support 7 | Present | 0.2500 | Porous base material 1 | Present | Cu | 10 | A | B | B |
| Ex. 13 | Organic support 8 | Present | 0.3600 | Porous base material 1 | Present | Cu | 10 | A | B | C |
| Ex. 14 | Absent | — | 0.0000 | Porous base material 1 | Present | Cu | 10 | B | — | — |

It is seen from Table 1 that the resistance variation was small in all of Example 1 to Example 13. Particularly, in Example 1 to Example 10, not only did the organic support and the separator had close adhesiveness, but the degree of damage on the separator was inhibited to a low level and was a nonproblematic level for practical use. On the other hand, in Example 14, the resistance variation was large because the multilayer body for a battery was free of an organic support.

Hence, it can be concluded that unlike the multilayer body for a battery of Example 14, the multilayer bodies for batteries of Example 1 to Example 13 were able to have a high surface smoothness and a restricted resistance variation by including the organic support over one surface of the porous base material. Hence, it can be concluded that lithium ion secondary batteries employing separators prepared by using the multilayer bodies for batteries of Example 1 to Example 13 would exhibit a good charging-discharging property.

Moreover, it can be concluded that the multilayer bodies for batteries of Examples 1 to 10 were able to maintain close adhesiveness between the organic support and the porous base material and to reduce damage on the porous base material when the organic support was peeled, by adjusting the peel force of the organic support, which was measured in the 180° peel test, to be 0.19 N/cm or lower. Hence, it can be concluded that lithium ion secondary batteries employing separators prepared by using the multilayer bodies for batteries of Example 1 to Example 10 would exhibit a better charging-discharging property.

Hence, the embodiment has been described as above. The embodiment described above is presented as an example, and the present invention is not limited by the embodiment described above. The embodiment described above can be carried out in other various modes, and various combinations, omissions, replacements, and modifications are applicable within the scope of the spirit of the invention. The embodiment and modifications thereof are included in the scope and spirit of the invention, and are also included in the scope of the invention described in the claims and equivalents thereof.

Aspects of the embodiment of the present invention are, for example, as follows.
<1> A multilayer body for a battery, the multilayer body including:
a separator including
   a porous base material formed in a plate shape, and
   an inorganic material layer situated over either or both of opposite principal surfaces of the porous base material; and
an organic support over which the separator is laminated.
<2> The multilayer body for a battery according to <1>,
wherein a peel force of the organic support when peeling the organic support from the porous base material in a 180° peel test is higher than 0 N/cm and lower than or equal to 0.2 N/cm.
<3> The multilayer body for a battery according to <1> or <2>,
wherein a thickness of the inorganic material layer is from 1 nm through 1 μm.
<4> The multilayer body for a battery according to any one of <1> to <3>,
wherein the inorganic material layer contains one or more components selected from the group consisting of Cu, C, Sn, Al, Si, Bi, Ag, and Au.
<5> The multilayer body for a battery according to any one of <1> to <4>,
wherein the porous base material contains polyvinylidene fluoride, polyethylene, and polyvinylidene fluoride, which are laminated in this order.
<6> The multilayer body for a battery according to any one of <1> to <5>,
wherein a thickness the separator is from twice through 5 times as large as a thickness of the organic support.
<7> The multilayer body for a battery according to any one of <1> to <6>,
wherein the multilayer body for a battery is for a nonaqueous electrolyte secondary battery.
<8> A method for producing the multilayer body for battery separators of any one of <1> to <7>, the method including:
laminating the porous base material over the organic support to form a complex body; and
forming the inorganic material layer over a principal surface of the complex body on a side of the porous base material by a sputtering method while conveying the complex body in a roll-to-roll manner.

The present application is based on and claims priority to Japanese Patent Application No. 2021-106551, filed Jun. 28, 2021. The entire content of Japanese Patent Application No. 2021-106551 is incorporated herein by reference.

### REFERENCE SIGNS LIST

10 multilayer body for a battery
11 organic support
12 separator
121 porous base material
122 inorganic material layer

1. A multilayer body for a battery, the multilayer body comprising:
a separator including
a porous base material formed in a plate shape, and
an inorganic material layer situated over either or both of opposite principal surfaces of the porous base material; and
an organic support over which the separator is laminated.

2. The multilayer body for a battery according to claim 1,
wherein a peel force of the organic support when peeling the organic support from the porous base material in a 180° peel test is higher than 0 N/cm and lower than or equal to 0.2 N/cm.

3. The multilayer body for a battery according to claim 1,
wherein a thickness of the inorganic material layer is from 1 nm through 1 μm.

4. The multilayer body for a battery according to claim 1,
wherein the inorganic material layer contains one or more components selected from the group consisting of Cu, C, Sn, Al, Si, Bi, Ag, and Au.

5. The multilayer body for a battery according to claim 1,
wherein the porous base material contains polyvinylidene fluoride, polyethylene, and polyvinylidene fluoride, which are laminated in this order.

6. The multilayer body for a battery according to claim 1,
wherein a thickness the separator is from twice through 5 times as large as a thickness of the organic support.

7. The multilayer body for a battery according to claim 1,
wherein the multilayer body for a battery is for a nonaqueous electrolyte secondary battery.

8. A method for producing the multilayer body for a battery of claim 1, the method comprising:
laminating the porous base material over the organic support to form a complex body; and
forming the inorganic material layer over a principal surface of the complex body on a side of the porous base material by a sputtering method while conveying the complex body in a roll-to-roll manner.
